(19) United States
(12) Patent Application Publication
(10) Pub. No.: US 2011/0021818 A1
(43) Pub. Date: Jan. 27, 2011

(54) AZABORINE COMPOUNDS AS HYDROGEN STORAGE SUBSTRATES

(76) Inventors: Shih-Yuan Liu, Eugene, OR (US); Pat Campbell, Eugene, OR (US); Kshitij Parab, Richland, WA (US)

Correspondence Address: KLARQUIST SPARKMAN, LLP, 121 SW SALMON STREET, SUITE 1600, PORTLAND, OR, 97204, US

(21) Appl. No.: 12/844,797

(22) Filed: Jul. 27, 2010

Related U.S. Application Data
(60) Provisional application No. 61/228,883, filed on Jul. 27, 2009.
(60) Provisional application No. 61/228,893, filed on Jul. 27, 2009.

(51) Int. Cl. C07F 5/02; B01J 19/00

(52) U.S. Cl. 564/10; 422/129

(57) ABSTRACT

Selected 1,2-azaborine compounds exhibit utility as hydrogen storage substrates, and are useful as components of hydrogen storage devices.

### CROSS-REFERENCE TO RELATED APPLICATIONS

This applications claims the benefit under 35 U.S.C. §119(e) of the priority of U.S. Provisional Patent Application No. 61/228,883 titled 1,2-AZABORINE HETEROCYCLES filed Jul. 27, 2009; and U.S. Provisional Patent Application No. 61/228,893 titled AZABORINE COMPOUNDS AS HYDROGEN STORAGE SUBSTRATES filed Jul. 27, 2009, each hereby incorporated by reference.

As provided for by the terms of grant no. DE-FG36-08G018143 awarded by the Department of Energy, the U.S. Government has certain rights in the invention.

### BACKGROUND

In attempting to satisfy the increasing global demand for energy, attention has shifted from petroleum-based energy sources to alternative energy sources that can be sustained in a carbon-neutral economy, particularly for automotive use. Hydrogen, arguably the cleanest of all fuel sources, producing only water as a byproduct, has emerged as a leading carbon-neutral energy alternative.

The efficient and safe storage of hydrogen is a crucial component for the development of a hydrogen-based energy infrastructure. Hydrogen is a highly flammable gas with low density under standard conditions, presenting challenges for both its transport and storage. Unfortunately, neither compressed (40 g/L at 700 bar) or liquefied (70 g/L at 20K) hydrogen provides a practical solution for automotive use. Potential hydrogen storage approaches include the use of metal hydrides, hydrogen-sorbent materials, and chemical hydride systems.

Recyclability (i.e., the ability to regenerate spent fuel) is an important aspect of a successful hydrogen storage system, and the ideal reductant for regenerating spent fuel would be molecular hydrogen. Therefore, a hydrogen storage substrate should possess one or more of the following characteristics:
(a) Well-defined molecular species throughout the entire fuel lifecycle;
(b) possesses high H₂ storage capacities;
(c) exhibits an appropriate enthalpy of H₂ desorption that is conducive to regeneration by H₂; and
(d) liquids at the desired operating temperatures.

Ammonia borane (H₃N—BH₃ or AB) has shown promise among chemical hydride materials, exhibiting a gravimetric density of 19.6 wt % H₂. While the release of H₂ from AB and its derivatives has been extensively investigated in the recent past, the issue of spent fuel regeneration has received less attention. This is arguably due to the complicated and ill-defined nature of the various spent fuels produced from AB dehydrogenation.

1,2-Azaborines are heterocyclic analogs of aromatic 6-membered rings. Azaborine compounds possess particularly advantageous properties as hydrogen storage substrates due to the favorable thermodynamics of their hydrogen release/uptake and their relatively high capacity for H₂ storage. 1,2-Azaborines present significant potential as components of hydrogen storage devices.

### BRIEF DESCRIPTION OF THE FIGURES

FIG. 1 depicts a representative hydrogen storage cycle according to an exemplary embodiment of the invention.

### DETAILED DESCRIPTION

1,2-Azaborines are heterocyclic analogs of aromatic 6-membered rings, and may be described by the following formula:

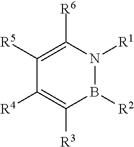

where the R¹ substituent is halogen, alkyl having 1-6 carbons, aryl having 1-6 carbons, heteroaryl having 1-6 carbons, acyl having 1-6 carbons, alkenyl having 1-6 carbons, alkynyl having 1-6 carbons, sulfonyl, —OR⁷, —SR⁷, or Si(R⁸)₃. Each R⁷ is independently hydrogen, alkyl having 1-6 carbons, acyl having 1-6 carbons, alkenyl having 1-6 carbons, tert-butyloxycarbonyl, or sulfonyl. Each R⁸ is independently alkyl having 1-6 carbons, aryl having 1-6 carbons, alkoxy having 1-6 carbons, acyl having 1-6 carbons, alkenyl having 1-6 carbons, and tert-butyloxycarbonyl.

The R² substituent is hydrogen, halogen, acyl having 1-6 carbons, amide, amine, —CN, —OR⁷, —SR⁷, alkyl having 1-6 carbons, alkenyl having 1-6 carbons, alkynyl having 1-6 carbons, or R² is an aromatic heterocycle. Alternatively R¹ and R² taken in combination form a fused 5- or 6-membered ring that optionally incorporates one or more heteroatoms, and that is itself optionally further substituted by alkyl having 1-6 carbons, aryl having 1-6 carbons, acyl having 1-6 carbons, tert-butyloxycarbonyl, or Si(R⁸)₃.

The R³-R⁶ substituents are independently hydrogen, halogen, alkyl having 1-6 carbons, acyl having 1-6 carbons, amide, amine, —CN, —OR⁷, —SR⁷, alkenyl having 1-6 carbons, alkynyl having 1-6 carbons, aryl having 1-6 carbons, or heteroaryl having 1-6 carbons.

The 1,2-azaborine compounds can accept 3 formal equivalents of dihydrogen when completely reduced, as shown below in Scheme 1 for 1,2-azaborine itself. A formal equivalent of dihydrogen is two hydrogen atoms, whether the hydrogen atoms are added to the substrate as dihydrogen (during hydrogenation), as hydride ions, or as protons. For example, the combination of a hydride ion and a proton formally constitutes one equivalent of dihydrogen. When completely reduced, the 1,2-azaborine compounds are formally substituted by 6 hydrogen atoms, or 3 formal equivalents of dihydrogen. As shown in Scheme 1, the energetics of hydrogen desorption have been calculated. In particular, for the reverse of the hydrogenation reaction the Gibbs free energy of desorption is negative, indicating that recovery of dihydrogen from the substrate is favorable.

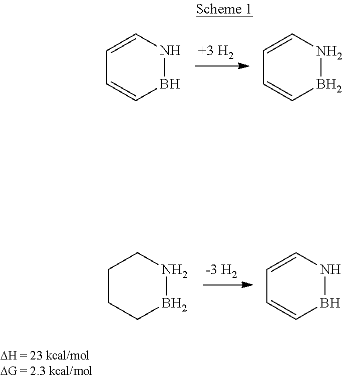

If their hydrogenation behavior is the same, then the difference in bulk hydrogen capacity between two distinct azaborine materials will be largely determined by the weight and density of the two compounds. Higher hydrogen storage capacities may be obtained by using smaller and more sterically compact azaborines, increasing the amount of hydrogen that can be stored per unit volume. Compounds wherein R³-R⁶ are hydrogen are therefore preferred, as are compounds where R¹ and R² are hydrogen or lower alkyl, such as t-butyl.

It should be appreciated, however, that careful selection of ring substituents may be used to customize or fine-tune the chemical nature of the azaborine substrates. For example alkyl substitution may create substrates with enhanced organic solubilities, while charged side chains (such as sulfoalkyl, or carboxyalkyl) will result in more polar compounds. Additionally, the electron-donating or withdrawing nature of a given substituent or substituents may influence the reactivity of a given substrate to hydrogenation, or the facility with which that substrate can be regenerated.

Additionally, the preparation of azaborine substrates having one or more fused rings or other substituents may permit the storage of greater than 3 equivalents of dihydrogen per substrate molecule, by providing additional sites of unsaturation where hydrogenation may occur. The azaborine substrates may therefore be optimized for a given hydrogen storage application using screening methods well known in the art.

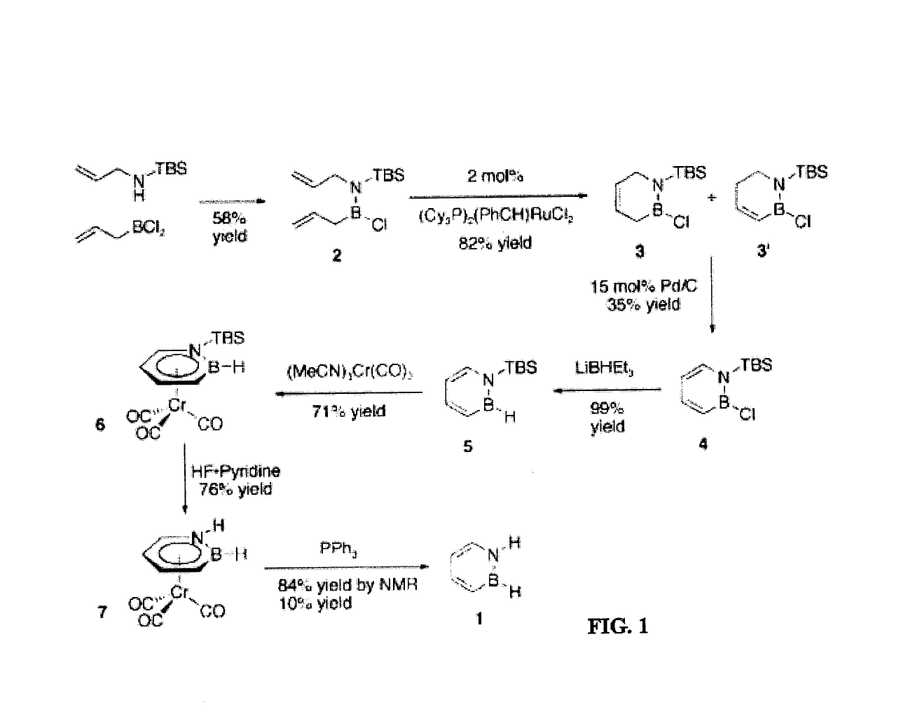

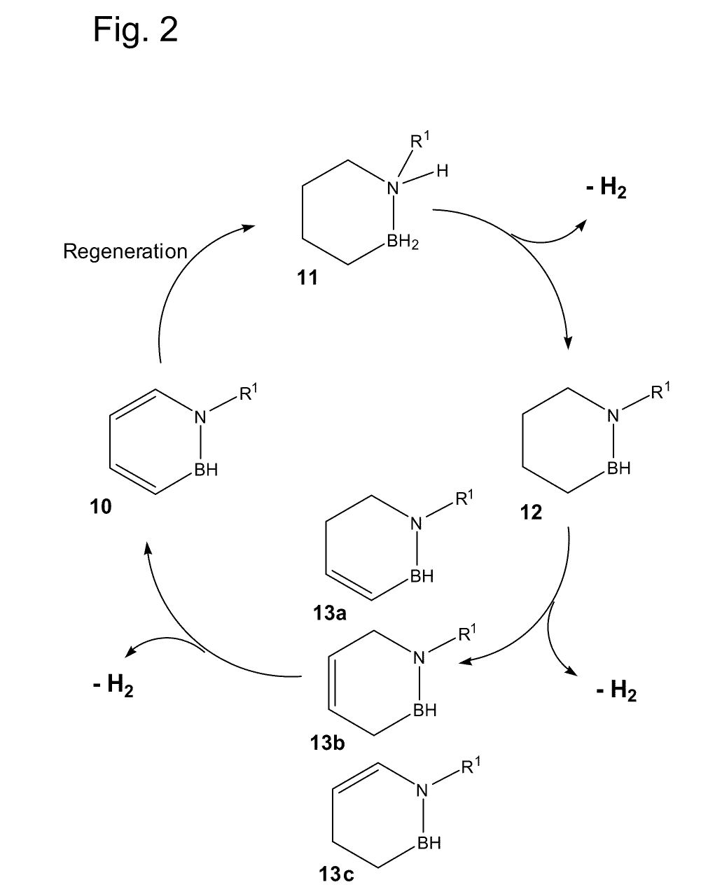

A hydrogen storage cycle for an exemplary 1,2-azaborine derivative 10 is shown in FIG. 1. The cycle depicts the stepwise loss of dihydrogen equivalents from the fully charged, i.e. reduced, compound 11. The sequential loss of a first equivalent of dihydrogen yields compound 12, and loss of a second equivalent of dihydrogen yields one of isomeric compounds 13a, 13b, and 13c. The loss of the final and third equivalent of dihydrogen yields the spent compound 10. Reduction of compound 10 by hydrogenation regenerates compound 11.

The presently disclosed azaborine compounds are well-suited to acting as substrates for hydrogen storage: They possess well-defined molecular structure throughout the entire hydrogen storage lifecycle, they possess a high H₂ storage capacity; they exhibit an appropriate enthalpy of H₂ desorption that permits ready regeneration by H₂; and they are either liquids, or are capable of being dissolved in liquids under the desired operating conditions. In addition, the hydrogenation of the subject compounds is readily reversible, regenerating the well-characterized original substrate.

The presently disclosed compounds therefore lend themselves to a method of hydrogen storage, the method including the steps of a) providing an azaborine substrate as described above; b) hydrogenating the azaborine substrate with at least one equivalent of dihydrogen.

The step of hydrogenation typically reduces the multiple bonds present in the azaborine substrate, and may occur in the presence of a hydrogenation catalyst. The hydrogenation catalyst may be a homogeneous catalyst or a heterogeneous catalyst. The hydrogenation catalyst may include one or more platinum group metals, including for example platinum, palladium, rhodium (such as Wilkinson's catalyst), ruthenium, iridium (such as Crabtree's catalyst), or nickel (such as Raney nickel or Urushibara nickel).

Alternatively or in addition, the step of hydrogenation may include reducing the azaborine substrate with a source of hydride. The hydride typically formally adds to the ring boron atom of the azaborine substrate. When used in combination, the substrate may first be hydrogenated to yield a saturated intermediate, and the saturated intermediate then reacts with hydride.

Alternatively or in addition, the step of hydrogenation may include protonation of the ring nitrogen atom of the azaborine substrate. In one aspect of the method, protonation occurs at a saturated intermediate anion.

The method may further comprise the restoration of the original unsaturated azaborine substrate by releasing one or more equivalents of dihydrogen from the saturated substrate (hydrogen desorption). Typically, the desorption of dihydrogen from the saturated substrate is energetically favorable, that is, the dehydrogenation has a negative Gibb's free energy (ΔG).

Another aspect of the invention is a hydrogen storage system that includes azaborine hydrogen storage substrates as described above. Where the disclosed 1,2-azaborines are used in a hydrogen storage system, the compounds are typically present in a liquid phase, such as dissolved in a suitable organic solvent. The hydrogen storage device and/or liquid phase may include one or more catalysts, solvents, salts, clathrates, crown ethers, carcarands, acids, and bases. The hydrogen storage system may include a port for the introduction of hydrogen for subsequent storage. Similarly, it may include a tap or port for the collection of regenerated hydrogen gas.

Such a hydrogen storage system may be incorporated into a portable power cell, or may be installed in conjunction with a hydrogen-burning engine. The hydrogen storage system may be used in or with a hydrogen-powered vehicle, such as an automobile. Alternatively, the hydrogen storage device may be installed in or near a residence, as part of a single-home or multi-home hydrogen-based power generation system. Larger versions of the hydrogen storage device may be used in conjunction with, or in replacements for, conventional power generating stations.

The hydrogen storage system may also utilize one or more additional methods of hydrogen storage in combination with the disclosed azaborine hydrogen storage substrates, including storage via compressed hydrogen, liquid hydrogen, and/or slush hydrogen. Alternatively, or in addition, the hydrogen storage system may include alternative methods of chemical storage, such as via metal hydrides, carbohydrates, ammonia, amine borane complexes, formic acid, ionic liquids, phosphonium borate, or carbonite substances, among others. Alternatively, or in addition, the hydrogen storage system may include methods of physical storage, such as via carbon nanotubes, metal-organic frameworks, clathrate hydrates, doped polymers, glass capillary arrays, glass microspheres, or keratine, among others.

### Model Compounds and Examples

### Example 1

### Synthesis of 1,2-Dihydro-1,2-azaborine

Scheme 1 illustrates a synthetic route to 1,2-dihydro-1,2-azaborine, compound 1. Coupling of allylboron dichloride (generated in situ) with tert-butyldimethylsilyl allyl amine (TBS allyl amine) furnished diene compound 2. Using first-generation Grubbs catalyst, ring-closing metathesis of intermediate 2 yielded an isomeric mixture of 3 and 3′ (in a 60:40 ratio) in 82% yield. Dehydrogenation of this mixture was carried out in the presence of catalytic amounts of Pd/C to generate compound 4. Treatment of heterocycle 4 with LiBHEt₃ installed the B—H functionality to give compound 5 in quantitative yield. Complexation of 1,2-azaborine 5 to [Cr(CO)₃] produced the piano-stool adduct compound 6. Subsequent removal of the N-protecting group gave compound 7 in 76% yield. Finally, decomplexation of 1 from [Cr(CO)₃] was accomplished using triphenylphosphine. Compound 1 was isolated in 10% yield by fractional vacuum transfer in the presence of a low-boiling reaction solvent, isopentane.

The inherent efficiency of the decomplexation reaction (84% yield) was measured by ¹H NMR spectroscopy against an internal standard. The melting point of Compound 1 is −45° C., which is slightly higher than that of borazine (−58° C.) but considerably lower than that of benzene (5° C.). We found 1,2-dihydro-1,2-azaborine 1 to be a relatively stable heterocycle. ¹H NMR spectroscopy of a 0.7 m solution of 1 in CD₂Cl₂ showed no appreciable degradation when the solution was heated to 60° C. for five days. Furthermore, 1 is stable to chromatography on silica gel and is relatively nonpolar (Rf=0.4 with pentane as eluent). Details of the synthetic route may be found in the chemical literature (Angew. Chem. Int. Ed. 2009, 48, 973-977, hereby incorporated by reference).

It should be appreciated that numerous modifications to starting materials, reagents, and/or reaction conditions may be made in order to produce 1,2-azaborine compounds having the desired substituents and substitution patterns.

### Example 2

### Preparation and Hydrogenation of a Model Fuel

Known compound 14 (J. Am. Chem. Soc. 2010, 130, 7250; hereby incorporated by reference) was treated with LiHBEt₃ yielded partially reduced compound 15 as a clear colorless liquid in 74% isolated yield. Subsequent dehydrogenation over catalytic amounts of Pd/C produced the desired model compound 16, also as a low-melting liquid (Scheme 2).

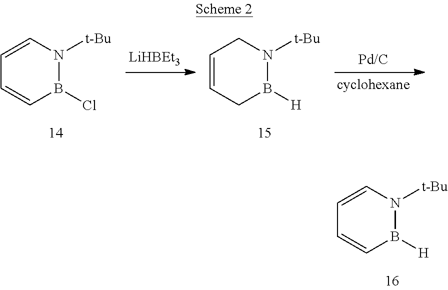

Compound 16 readily takes up H₂ to furnish 17 under mild conditions (Scheme 3). Full conversion was achieved in 4 hours at a hydrogen pressure of 45 psi (“3 atm) at 80° C. in the presence of catalytic amounts of Pd/C. Compound 17 was isolated as a clear low-melting liquid in only 41% yield after distillation, although both NMR and GC analysis indicates that the actual hydrogenation reaction is a high-yield process.

### Example 3

### Comparing Hydrogenation of Compound 16 with Benzene and t-Butylbenzene

Benzene and tert-butylbenzene were treated under the same conditions as compound 16 (see Scheme 3). As discussed in Example 1, compound 16 was generated in 41% yield, while neither benzene nor butylbenzene exhibited a reaction. This suggests that the activation barrier for hydrogen uptake is substantially lower for azaborine heterocycles than for the corresponding aromatic carbocycles.

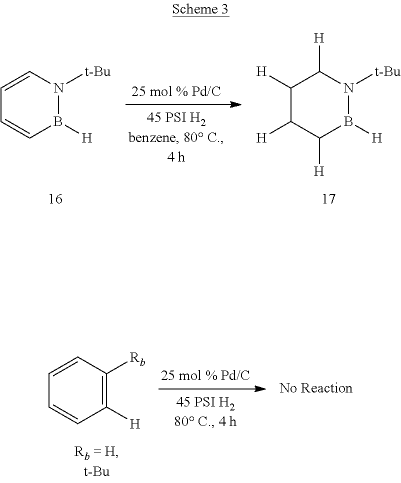

### Example 4

### Additional Hydrogenation of Compound 17

Hydrogenation across the BN bond of compound 17 did not produce the fully reduced compound 18. In order to evaluate the fully hydrogenated compound, we treated compound 17 with the sequential addition of hydride and proton equivalents (see Scheme 4). Specifically, treatment of compound 17 with KH in the presence of a crown ether furnished the desired adduct compound 19 in 90% isolated yield. Subsequent protonation of 19 produced the fully reduced material 18, as observed by NMR spectroscopy. It was determined that a crown ether was not needed to facilitate the desired reaction, and that the addition of KH to compound 17 in THF followed by protonation with HCl in a single pot produced the hydrogenated compound 18 in 71% isolated yield over two steps. Intermediate compound 20 was formed in high yield as measured by NMR analysis but was not isolated.

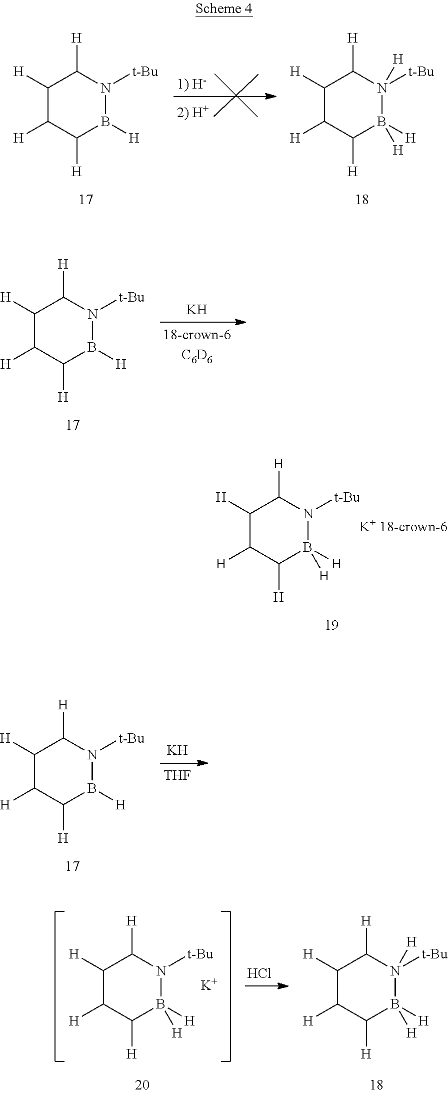

The hydrogenation route shown in Schemes 3 and 4 (hydrogenation over palladium followed by treatment with hydride and acid) represents a simple, atom-economical way to regenerate spent azaborine heterocycle substrate. In addition, the synthetic availability of azaborine-cyclohexane derivatives (i.e., fully reduced substrate) permit tailoring and customization of the substrate for specific characteristics useful for hydrogen desorption from these materials.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

What is claimed is:

1. A method of hydrogen storage, comprising
a) providing an azaborine substrate having the formula 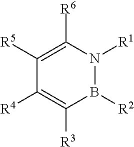
wherein R¹ is halogen, alkyl having 1-6 carbons, aryl having 1-6 carbons, heteroaryl having 1-6 carbons, acyl having 1-6 carbons, alkenyl having 1-6 carbons, alkynyl having 1-6 carbons, sulfonyl, —OR⁷, —SR⁷, or Si(R⁸)₃ where each R⁷ is independently hydrogen, alkyl having 1-6 carbons, acyl having 1-6 carbons, alkenyl having 1-6 carbons, tert-butyloxycarbonyl, or sulfonyl; each R⁸ is independently alkyl having 1-6 carbons, aryl having 1-6 carbons, alkoxy having 1-6 carbons, acyl having 1-6 carbons, alkenyl having 1-6 carbons, or tert-butyloxycarbonyl;
R² is hydrogen, halogen, acyl having 1-6 carbons, amide, amine, —CN, —OR⁷, —SR⁷, alkyl having 1-6 carbons, alkenyl having 1-6 carbons, alkynyl having 1-6 carbons, or R² is an aromatic heterocycle; or R¹ and R² taken in combination form a fused 5- or 6-membered ring that optionally incorporates one or more heteroatoms, and that is itself optionally further substituted by alkyl having 1-6 carbons, aryl having 1-6 carbons, acyl having 1-6 carbons, tert-butyloxycarbonyl, or Si(R⁸)₃;
R³-R⁶ are independently hydrogen, halogen, alkyl having 1-6 carbons, acyl having 1-6 carbons, amide, amine, —CN, —OR⁷, —SR⁷, alkenyl having 1-6 carbons, alkynyl having 1-6 carbons, aryl having 1-6 carbons, or heteroaryl having 1-6 carbons;
b) hydrogenating the azaborine substrate with at least one formal equivalent of dihydrogen.

2. The method of claim 1, wherein hydrogenating the azaborine substrate includes hydrogenating the azaborine substrate with three formal equivalents of dihydrogen.

3. The method of claim 2, wherein the hydrogenated azaborine substrate has the formula

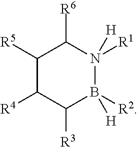

4. The method of claim 1, further comprising releasing one or more equivalents of dihydrogen from the hydrogenated azaborine substrate.

5. The method of claim 1, wherein hydrogenating the azaborine substrate includes reducing at least one multiple bond in the azaborine substrate.

6. The method of claim 5 wherein hydrogenating the azaborine substrate occurs in the presence of a hydrogenation catalyst.

7. The method of claim 1, wherein hydrogenating the azaborine substrate includes reducing the azaborine substrate with a source of hydride.

8. The method of claim 7 wherein the hydride adds to the boron atom of the azaborine substrate.

9. The method of claim 1, wherein hydrogenating the azaborine substrate includes protonating the ring nitrogen atom of the azaborine substrate.

10. The method of claim 1, wherein hydrogenating the azaborine substrate includes:
a) reducing at least one multiple bond in the azaborine substrate to yield a saturated intermediate;
b) reducing the saturated intermediate with a source of hydride; and
c) protonating the ring nitrogen atom of the azaborine substrate.

11. The method of claim 1, wherein providing the azaborine substrate includes providing a substrate wherein R³-R⁶ are hydrogen.

12. The method of claim 1, wherein providing the azaborine substrate includes providing a substrate wherein R¹ and R² are hydrogen or lower alkyl.

13. The method of claim 1, wherein providing the azaborine substrate includes providing a substrate having the formula 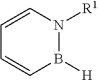
wherein R¹ is H or tert-butyl.

14. A hydrogen storage system, comprising:
an azaborine substrate having the formula 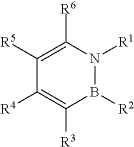
wherein R¹ is halogen, alkyl having 1-6 carbons, aryl having 1-6 carbons, heteroaryl having 1-6 carbons, acyl having 1-6 carbons, alkenyl having 1-6 carbons, alkynyl having 1-6 carbons, sulfonyl, —OR⁷, —SR⁷, or Si(R⁸)₃ where each R⁷ is independently hydrogen, alkyl having 1-6 carbons, acyl having 1-6 carbons, alkenyl having 1-6 carbons, tert-butyloxycarbonyl, or sulfonyl; each R⁸ is independently alkyl having 1-6 carbons, aryl having 1-6 carbons, alkoxy having 1-6 carbons, acyl having 1-6 carbons, alkenyl having 1-6 carbons, or tert-butyloxycarbonyl;
R² is hydrogen, halogen, acyl having 1-6 carbons, amide, amine, —CN, —OR⁷, —SR⁷, alkyl having 1-6 carbons, alkenyl having 1-6 carbons, alkynyl having 1-6 carbons, or R² is an aromatic heterocycle; or R¹ and R² taken in combination form a fused 5- or 6-membered ring that optionally incorporates one or more heteroatoms, and that is itself optionally further substituted by alkyl having 1-6 carbons, aryl having 1-6 carbons, acyl having 1-6 carbons, tert-butyloxycarbonyl, or Si(R⁸)₃;
R³-R⁶ are independently hydrogen, halogen, alkyl having 1-6 carbons, acyl having 1-6 carbons, amide, amine, —CN, —OR⁷, —SR⁷, alkenyl having 1-6 carbons, alkynyl having 1-6 carbons, aryl having 1-6 carbons, or heteroaryl having 1-6 carbons.

15. The hydrogen storage system of claim 14, wherein the azaborine substrate is present in the storage system in a liquid phase.

16. The hydrogen storage system of claim 14, wherein the hydrogen storage system is incorporated into a portable power cell, or installed in conjunction with a hydrogen-burning engine.

17. The hydrogen storage system of claim 14, further comprising apparatus for hydrogenating the azaborine substrate.

18. The hydrogen storage system of claim 14, further comprising apparatus for recovering dihydrogen from a hydrogenated azaborine substrate.
